(19) United States
(12) Patent Application Publication
(10) Pub. No.: US 2006/0049611 A1
(43) Pub. Date: Mar. 9, 2006

(54) Bicycle Mounting Apparatus

(75) Inventor: Terence Stevens, Greensboro, NC (US)

Correspondence Address: TERENCE STEVENS, 3216 FIELDING PLACE, GREENSBORO, NC, 27405, US

(73) Assignee: Mrs. Cheryl Monique Stevens, Greensboro, NC (US)

(21) Appl. No.: 10/711,256

(22) Filed: Sep. 5, 2004

(51) Int. Cl. B62J 39/00

(52) U.S. Cl. 280/288.4

(57) ABSTRACT

An apparatus for mounting a bicycle in a manner which permits the removal of the body's weight from the pubic area and reduce buttocks pressure while adding therapeutic support to the lower lumbar-sacral region of the body. In a typical embodiment, the mounting apparatus includes a harness device that is worn by a rider. The harness device fits between the lower torso and upper thigh region of the body and has a projecting section attached to the rear. When a rider mounts a bicycle or pedaled vehicle, the projecting section comes in contact with and is supported by means of an adapted bicycle mounting post, thus bearing the riders weight with the harness device leaving sub scrotal arteries free of pressure.

### CROSS REFERENCE TO RELATED APPLICATIONS

U.S. Pat. No. 4,709,69212/1987 Kirschenberg . . . 128/78

U.S. Pat. No. 4,836,1946/1989 Sebastian . . . 128/78

U.S. Pat. No. 4,926,8455/1990 Harris . . . 128/78

U.S. Pat. No. 4,981,3061/1991 Young . . . 280/290

U.S. Pat. No. 6,206,3993/2001 Schnitzenbaumer . . . 280/304.4

U.S. Pat. No. 6,244,6116/2001 Davis . . . 280/290

### BACKGROUND OF INVENTION

Across the world, the bicycle has been a form of transportation and recreation for centuries. Despite numerous designs intended to make a bicycle seat that is more comfortable, modern seats have not changed from its original design.

The Traditional bicycle seat was designed to support the rider's weight on the buttocks and pubic area. The structure of the seat is comprised of a rear saddle that supports the buttocks and a forward horn that contacts the pubic area allowing lateral support and horizontal leg movement.

Recent literature states that prolonged pressure on the pubic structure of male riders can cause groin or penile numbness, immediate or delayed impotence and an elevated risk of prostate complications. Furthermore, constant buttocks slipping and pressure can cause soreness and lower back pain.

The problems associated with pelvic pressure are more apparent to riders that spend prolonged periods of time on a bicycle seat. Numerous scientific studies and designs have attempted to connect the human anatomy with the traditional bicycle seats. U.S. Pat. No. 6,554,355 Titled The Anatomical Bicycle Seat was designed to cushion the pubic area that contacts the seat. U.S. Pat. No. 6,471,291 Titled The Anatomically Correct Bicycle Seat and numerous others are designed to change the pressure point from the pelvic area to the buttocks, thus supporting all of the rider's weight on the ischial tuberosities.

It is apparent that prior arts have identified a major problem associated with pubic and buttocks pressure in bicycle seat designs. At this point none of the designs solve the anatomical problems or offer solutions.

### SUMMARY OF INVENTION

In view of the health concerns inherent in bicycle seats and other saddle devices, the general purpose of the present invention is to provide a bicycle mounting apparatus which has all the advantages of prior art designs without the discomforts and health risk.

The present invention is designed to provide a novel and relatively simple apparatus for mounting a bicycle in a manner, which permits the removal of the body's weight from the pubic area and reduce buttocks pressure while adding therapeutic support to the lower lumbar-sacral region of the body.

In a typical embodiment of the invention, the rider is provided a belt device that fits snugly against the lower torso. The belt device has a projecting section attached to its rear and can also come equipped with buttock straps and leg loops. When a rider mounts a bicycle or pedaled vehicle, the projecting section comes in contact with and is supported by an adapted bicycle mounting post thus jointly supporting the rider's weight with the belt device, buttocks straps and leg loops.

Other embodiment of this invention is a harness device that is padded for a rider's comfort. The harness device has a projecting section attached to its rear. When a rider mounts a bicycle or pedaled vehicle, the projecting section comes in contact with and is supported by an adapted bicycle mounting post thus bearing the riders weight by the harness device.

An object of the present invention is to transfer the rider's weight off the pubic area, thus eliminating the compression of sub-scrotal arteries or nerves that are necessary for the healthy function of the penis.

Another object of this invention is to distribute a major part of the rider's weight away from the buttock area thus reducing the effects of chafing and saddle sores that are common to long distance riders.

Another object of the present invention is to reduce lower back stress by adding a therapeutic appliance to the lumbar spine.

### BRIEF DESCRIPTION OF DRAWINGS

FIG. 1 is a cross sectional view taken of a seated rider as it relates to a prior art bicycle seat and pubic contact.

FIG. 2 is a cross sectional view of a seated rider as it relates to the present invention and pubic contact.

FIG. 3 is a rear perspective view of one embodiment of the present invention.

FIG. 4 is a right side view of a pedaling rider wearing an embodiment of the present invention.

FIG. 5 is a rear perspective view of a second embodiment of the present invention.

FIG. 6 is a rear perspective view of a pedaling rider wearing an embodiment of the present invention.

FIG. 7 is a rear perspective view of a standing rider wearing an embodiment of the present invention.

### DETAILED DESCRIPTION

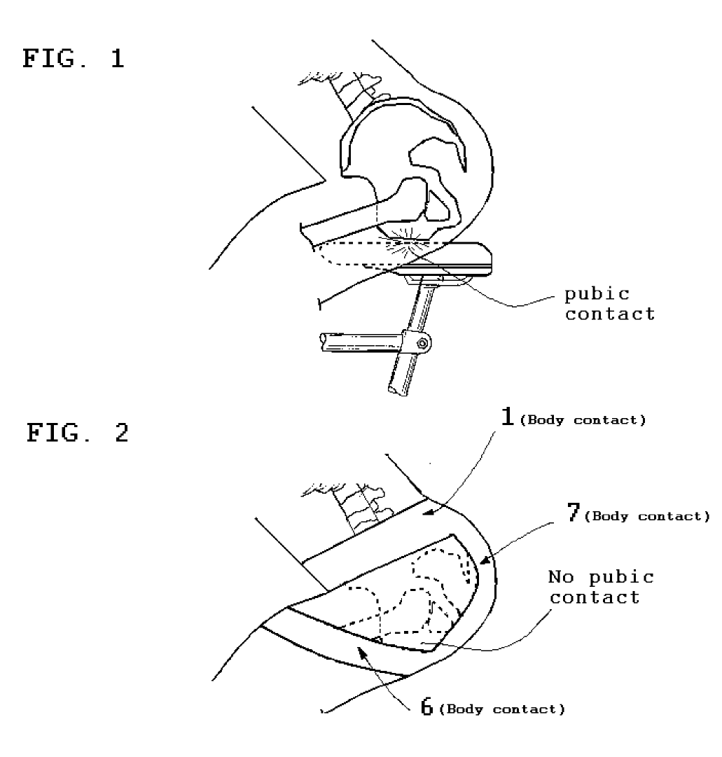

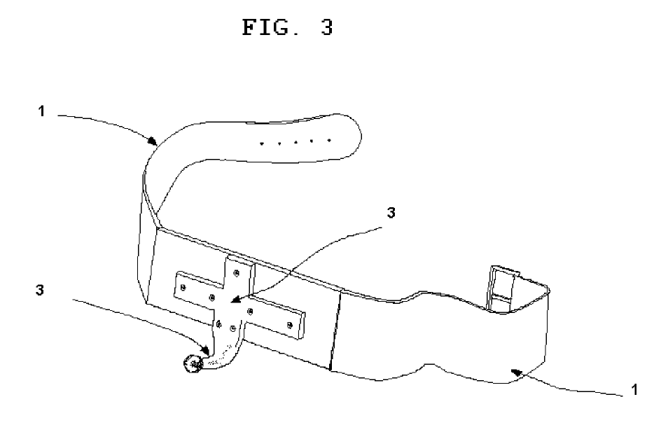

The best features of this invention are seen in FIG. 1 and FIG. 2. FIG. 1 shows the pubic and sub scrotal contact associated with prior art bicycle seats. FIG. 2 shows an embodiment of the present invention and the associated body contact points as the rider's weight is transferred from the pubic area and is distributed between belt devices 1, buttocks straps 7 and leg loops 6.

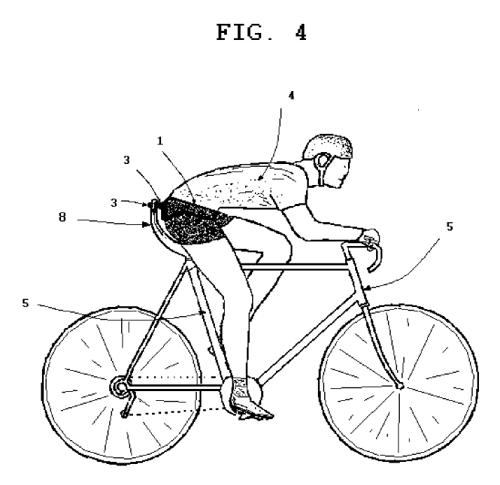

In FIG. 3, belt device 1 is to be worn around the waist of a rider and has projecting section 3 attached to the rear. As seen in FIG. 4, when rider 4 mounts bicycle 5 wearing the embodiment shown in FIG. 3, the projecting section 3 comes in contact with and is supported by bicycle mounting post 8, thus bearing the riders weight with belt device 1. In FIG. 3, projecting section 3 can be combined with belt device 1 as one component and constructed to lock, hook or rest against bicycle mounting post 8 of FIG. 4.

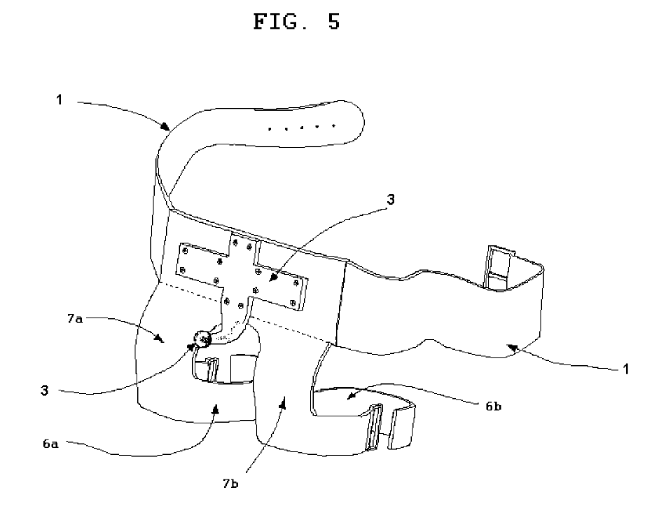

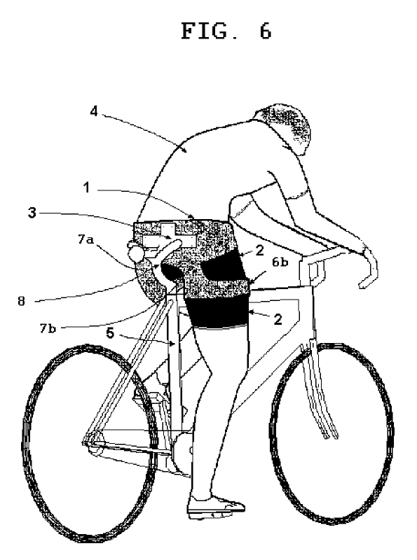

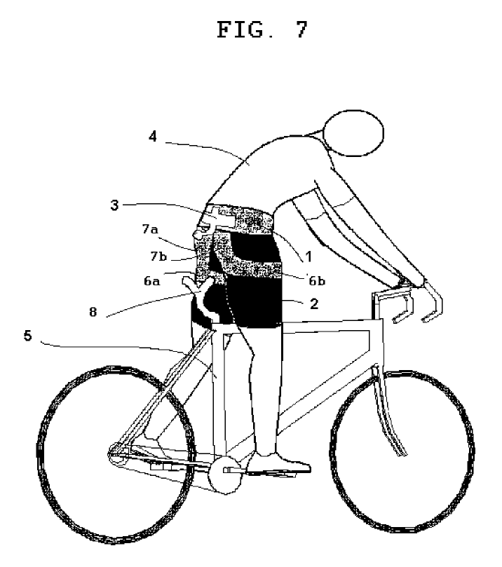

FIG. 5 shows a second embodiment of the present invention as left and right buttocks straps 7a and 7b along with left and right leg loops 6a and 6b are added to belt device 1. Also seen in FIG. 5, projecting section 3 is curved out from belt device 1 to add ease of insertion. When a rider mounts a bicycle or pedaled vehicle, the projecting section 3 comes in contact with and is supported by an adapted bicycle mounting post, thus bearing the riders weight with belt device 1, buttocks straps 7(a, b) and leg loops 6(a, b). Projecting section 3 can be combined with belt device 1, buttock straps 7(a, b) and leg loops 6(a, b) as one component. Rider 4 in FIG. 6 and FIG. 7 wears the embodiment shown in FIG. 5.

In FIG. 6 we see a rear view of an embodiment of this invention. When rider 4 mounts bicycle 5, the projecting section 3 comes in contact with and is supported by the adapted bicycle mounting post 8, thus bearing rider 4's weight with belt device 1, buttock straps 7(a, b) and leg loops 6(a, b).

To show that the bicycle mounting apparatus presented in this invention has all the advantages of prior art designs, rider 4 in FIG. 7, stands to pedal bicycle 5. All of the embodiments presented in the present invention give a rider the freedom to mount and dismount without obstructions.

The bicycle mounting apparatus presented in this invention can be made in many belt and harness fitting designs. It is preferably made to fit around a rider's lower torso, buttocks and the upper thigh region of the body. The mounting apparatus presented can also be design to harness the upper torso to add support and stability.

The bicycle mounting apparatus presented in this invention is lightweight and easy to dress. As seen in FIG. 6, the mounting apparatus shown is made as a harness device to fit over trousers 2. The bicycle mounting apparatus presented in this invention can also be made into the trousers to be displayed as one piece of clothing.

The bicycle mounting apparatus presented in this invention is preferably made of a soft material to add comfort to a rider's body and an externally rugged material to bear weight during continuous pedaling.

What is claimed is:

1. A bicycle mounting apparatus comprising:
(a) A belt device that fits around the lower torso of a rider;
(b) A projecting section connected to said belt device, and said projecting section being constructed to come in contact with and be supported by means of an adapted bicycle.

2. The bicycle mounting apparatus set fourth in claim 1 wherein said belt device has buttock straps connected to the rear and said buttocks straps are connected to a left and right leg loop.

3. A bicycle mounting apparatus comprising:
(a) A harness device that is worn by a rider;
(b) A projecting section connected to said harness device, and said projecting section being constructed to come in contact with and be supported by means of an adapted bicycle.

4. A bicycle mounting apparatus comprising:
(a) Trousers that are adapted for comfort and worn by a rider;
(b) A projecting section connected to said trousers, and said projecting section being constructed to come in contact with and be supported by means of an adapted bicycle.

5. A method for mounting a bicycle, comprising:
(a) A harness device that is adapted to support the body's weight;
(b) A projecting section connected to said harness device, and said projecting section being constructed to come in contact with and be supported by means of an adapted bicycle.

6. A method for mounting a bicycle, comprising:
(a) A belt device adapted to support the bodies weight and is worn around the lower torso;
(b) A projecting section connected to said belt device, and said projecting section being constructed to come in contact with and be supported by means of an adapted bicycle.
